(19) United States
(12) Patent Application Publication
(10) Pub. No.: US 2011/0302637 A1
(43) Pub. Date: Dec. 8, 2011

(54) SOFTWARE DISTRIBUTION METHOD, INFORMATION PROCESSING APPARATUS, AND INFORMATION PROCESSING SYSTEM

(75) Inventor: Ryoh Hamada, Osaka-Shi (JP)

(73) Assignee: SHARP KABUSHIKI KAISHA, Osaka (JP)

(21) Appl. No.: 13/154,998

(22) Filed: Jun. 7, 2011

(30) Foreign Application Priority Data
Jun. 8, 2010 (JP) 2010-131220

(51) Int. Cl. G06F 21/00

(52) U.S. Cl. 726/5

(57) ABSTRACT

A distribution server receives authentication information acquired from an IC card reader of a client PC and authenticated by an authentication server. The distribution server adds setting information on the basis of the received authentication information in an installer of a device driver for an image formation section of an MFP to thereby generate a custom installer of the device driver. The distribution server distributes the generated custom installer to an address of a user to be authenticated based on the authentication information.

### CROSS-REFERENCE TO RELATED APPLICATIONS

This Nonprovisional application claims priority under 35 U.S.C. §119(a) on Patent Application No. 2010-131220 filed in Japan on Jun. 8, 2010, the entire contents of which are hereby incorporated by reference.

### BACKGROUND

1. Technical Field

The present invention relates to a software distribution method, an information processing apparatus, and an information processing system, which generate and distribute setting information for setting parameters required for executing predetermined software by a second information processing apparatus.

2. Description of Related Art

Conventionally, when a print request of a user is made from an information processing apparatus such as a personal computer (hereinafter referred to as a PC) or the like connected to a printer apparatus, the printer apparatus performs authentication of the user, cancels the print request of an unauthenticated user, and counts the number of paper sheets printed on the basis of the print request of an authenticated user on a per user basis. In addition, when a print request of a user which selects one of a plurality of printer apparatuses is made from one of a plurality of information processing apparatuses present in an office, a print server temporarily stores the print request, and the printer apparatus having received the print request from the print server performs authentication of the user and printing. With this operation, it becomes possible for the user to cause any arbitrary printing apparatus to perform printing.

For example, Japanese Patent Application Laid-Open No. 11-95938 (1999) discloses a print system in which a center-side data processing apparatus (print server) assigns one ID code to a data file and a data code for identifying the data file which are transmitted from a user-side data processing apparatus (information processing apparatus), and transmits the assigned ID code to the user-side data processing apparatus. When a data code and an ID code which are inputted in a printer match with the data code and the ID code assigned to the data code which are transmitted from the user-side data processing apparatus to the printer, the center-side data processing apparatus transmits the data file to the printer, and causes the printer to perform printing on the basis of the transmitted data file.

As described above, in order to improve security based on authentication and count the number of printed paper sheets on a per user basis without error, the printer apparatus and the print server normally cancel a print request which does not include proper authentication information of some sort. Consequently, it is necessary to preset the authentication information in software that transmits the print request to the printer apparatus and the print server. However, when erroneous authentication information is set, the print request is cancelled so that the setting of the authentication information, which is highly dependent on a manual operation, tends to be an impediment to the facilitation of installation of software for printing.

In contrast, Japanese Patent Application Laid-Open No. 2002-169673 discloses an image formation apparatus management system in which, when a DB (database) server receives a request for acquiring a printer driver for an image formation apparatus from a terminal apparatus, the DB server evaluates whether or not identification information unique to a user inputted in the terminal apparatus matches with identification information of the user pre-stored in the DB server. When the DB server evaluates that the identification information items match with each other, the DB server transmits a printer driver to which identification information of the image formation apparatus and the identification information of the user are added to the terminal apparatus. Since the printer driver is installed in the terminal apparatus, a setting in which the identification information of the user and the identification information of the image formation apparatus are added to print data to be transmitted to the DB server is automatically made in the terminal apparatus.

### SUMMARY

However, in the technology disclosed in Japanese Patent Application Laid-Open No. 2002-169673, the user is not able to separate the installation of the printer driver, which an information processing apparatus is caused to execute, from the authentication of the user performed by the DB server on the identification information unique to the user inputted from the terminal apparatus. Consequently, in the technology disclosed in Japanese Patent Application Laid-Open No. 2002-169673, there has been a problem that setting information for setting authentication information of a pre-authenticated user in pre-installed software such as the printer driver or the like can not be distributed. In addition, there has been a problem that it is not realistic to prepare each software package including a setting unique to a pre-authenticated user of which the number is equal to the number of users, and distribute different software packages to different users in order to obviate authentication executed at the time of installation of software such as the printer driver or the like.

The present invention has been achieved in view of the above-described circumstances, and an object thereof is to provide a software distribution method, an information processing apparatus, and an information processing system which are capable of generating setting information for performing a setting of parameters required for executing predetermined software in correspondence to a user on the basis of authentication information of the user, and distributing the generated setting information to all address of the user.

The software distribution method according to the present invention is a software distribution method for generating and distributing, by using an information processing apparatus, setting information for setting a parameter required for executing predetermined software by a second information processing apparatus. In the software distribution method, the information processing apparatus performs steps of receiving authentication information, generating the setting information on the basis of the received authentication information, and distributing the generated setting information to an address of a user to be authenticated based on the authentication information.

The software distribution method according to the present invention is a software distribution method for generating and distributing setting information for setting a parameter required for executing predetermined software by a second information processing apparatus by using a system including an information processing apparatus, an acquisition apparatus communicably connected to the information processing apparatus and acquiring authentication information, and an authentication apparatus communicably connected to the acquisition apparatus and receiving and authenticating the authentication information and transmitting an authentication result to a transmission source of the authentication information. In the software distribution method, the acquisition apparatus performs steps of transmitting the acquired authentication information to the authentication apparatus, receiving the authentication result and transmitting the authenticated authentication information to the information processing apparatus, and the information processing apparatus performs steps of receiving the authentication information, generating the setting information on the basis of the received authentication information, and distributing the generated setting information to an address of a user to be authenticated based on the authentication information.

In the software distribution method according to the present invention, the second information processing apparatus also functions as the acquisition apparatus.

In the software distribution method according to the present invention, the authentication apparatus performs steps of pre-storing an attribute of the user to be authenticated based on the authentication information, extracting the attribute of the authenticated user from the stored attribute, and adding the extracted attribute of the user in the authentication result, the acquisition apparatus performs a step of transmitting the attribute of the user included in the received authentication result to the information processing apparatus, and the information processing apparatus performs steps of receiving the attribute of the user, and adding information in correspondence to the received attribute of the user in the setting information.

In the software distribution method according to the present invention, the predetermined software and the setting information are distributed in the step of distributing the generated setting information to the address of the user.

In the software distribution method according to the present invention, the information processing apparatus performs steps of adding the setting information in the predetermined software and generating installation software for installing the predetermined software in the second information processing apparatus, and the installation software is distributed in the step of distributing the generated setting information to the address of the user.

In the software distribution method according to the present invention, the predetermined software is a device driver for an image formation apparatus for forming an image on the basis of image data transmitted by the second information processing apparatus.

The information processing apparatus according to the present invention is an information processing apparatus including a reception means for receiving authentication information, a generation means for generating, on the basis of the authentication information received by the reception means, setting information for setting a parameter required for executing predetermined software by a second information processing apparatus, and a distribution means for distributing the setting information generated by the generation means to an address of a user to be authenticated based on the authentication information.

The information processing system according to the present invention is an information processing system including the above-described information processing apparatus, an acquisition apparatus acquiring authentication information, transmitting the authentication information to an authentication apparatus, receiving an authentication result, and transmitting authenticated authentication information to the information processing apparatus, and the authentication apparatus receiving and authenticating the authentication information, and transmitting the authentication result to a transmission source of the authentication information.

In the present invention, the information processing apparatus distributes the setting information generated on the basis of the received authentication information to the address of the user to be authenticated based on the authentication information.

With this operation, when the authentication information of the user is authenticated and the information processing apparatus acquires the authenticated authentication information, the information processing apparatus distributes the setting information generated on the basis of the authentication information of the authenticated user to the address of the authenticated user. Subsequently, when the second information processing apparatus acquires the distributed setting information and applies the acquired setting information to the predetermined software, the setting of the parameter in correspondence to the user is performed.

In the present invention, the authentication apparatus authenticates the authentication information acquired by the acquisition apparatus, and transmits the authenticated authentication information to the information processing apparatus. The information processing apparatus distributes the setting information generated on the basis of the received authentication information to the address of the user to be authenticated based on the authentication information.

With this operation, the setting information generated on the basis of the authentication information acquired by the acquisition apparatus is distributed to the address of the user who has caused the acquisition apparatus to acquire the authentication information.

In the present invention, a user, distributed by the setting information, is scheduled to use the second information processing apparatus. Since the second information processing apparatus also functions as the acquisition apparatus, it is possible to save the user from moving to the place where another acquisition apparatus is installed in order to authenticate the authentication information.

In the present invention, the authentication apparatus extracts the attribute of the authenticated user from the pre-stored attributes and adds the attribute of the user in the authentication result, and the acquisition apparatus receives the authentication result including the attribute of the user from the authentication apparatus. Subsequently, the information processing apparatus adds the information in correspondence to the attribute of the user received from the acquisition apparatus in the setting information.

With this operation, the information processing apparatus distributes the setting information including the information in correspondence to the attribute of the authenticated user to the address of the authenticated user. Subsequently, when the second information processing apparatus acquires the distributed setting information and applies the acquired setting information to the predetermined software, the setting of the parameter in correspondence to the attribute of the user is performed in addition to the setting of the parameter in correspondence to the user.

In the present invention, since the predetermined software and the setting information are included in the software to be distributed, the necessary setting information is distributed to the user at the time of installation of the predetermined software at a time.

In the present invention, an installation package of the predetermined software is customized on a per user basis, and the customized installation package is distributed to the user.

With this operation, when the second information processing apparatus acquires the distributed installation package and executes the acquired installation package, the installation of the predetermined software and the setting of the parameter in correspondence to the user in the installed software are performed at a time.

In the present invention, the setting information for setting the parameter in the device driver (printer driver) for the image formation apparatus for forming the image on the basis of the image data transmitted by the second information processing apparatus is distributed to the address of the user.

With this operation, the setting information allows errorless setting of the parameter in correspondence to the user in the printer driver, which is considered to tend to cause troubles at the time of software installation, and is distributed to the address of the user.

According to the present invention, the setting information generated on the basis of the received authentication information is distributed to the address of the user.

With this operation, when the authentication information of the user is authenticated and the information processing apparatus acquires the authenticated authentication information, the information processing apparatus distributes the setting information generated on the basis of the authentication information of the authenticated user to the address of the authenticated user. Subsequently, when the second information processing apparatus acquires the distributed setting information and applies the acquired setting information to the predetermined software, the setting of the parameter in correspondence to the user is performed.

Consequently, it becomes possible to generate the setting information for performing the setting of the parameter required for executing the predetermined software in correspondence to the user on the basis of the authentication information of the user, and distribute the generated setting information to the address of the user, and the installation of the software is thereby facilitated.

The above and further objects and features will more fully be apparent from the following detailed description with accompanying drawings.

### BRIEF DESCRIPTION OF THE SEVERAL VIEWS OF THE DRAWINGS

FIG. 1 is a block diagram illustrating an example of a configuration of an authentication print system according to Embodiment 1 of the present invention;

FIG. 2 is a block diagram illustrating a configuration of a principal part of a distribution server;

FIG. 3 is a block diagram illustrating a configuration of a principal part of an authentication server;

FIG. 4 is a block diagram illustrating a configuration of a principal part of an MFP;

FIG. 5 is a flowchart illustrating an outline of a routine of each CPU in the authentication print system;

FIG. 6 is a flowchart illustrating a routine of each CPU in a client PC, the authentication server, and the distribution server, which are involved in generation and distribution of custom setting information;

FIG. 7 is a flowchart illustrating a routine of the CPU of the client PC involved in execution of an installer of a device driver;

FIG. 8 is an explanatory view illustrating an example of a setting screen of the device driver installed in the client PC;

FIG. 9 is a block diagram illustrating a configuration of a principal part of a distribution server according to Embodiment 2 of the present invention;

FIG. 10 is a flowchart illustrating a routine of each CPU in the client PC, the authentication server, and the distribution server, which are involved in generation and distribution of a custom installer; and

FIG. 11 is an explanatory view illustrating a configuration of the custom installer.

### DETAILED DESCRIPTION

A detailed description will be given hereinbelow of embodiments in which a software distribution system according to the present invention is applied to an authentication print system for performing printing on the basis of print data of an authenticated user.

### Embodiment 1

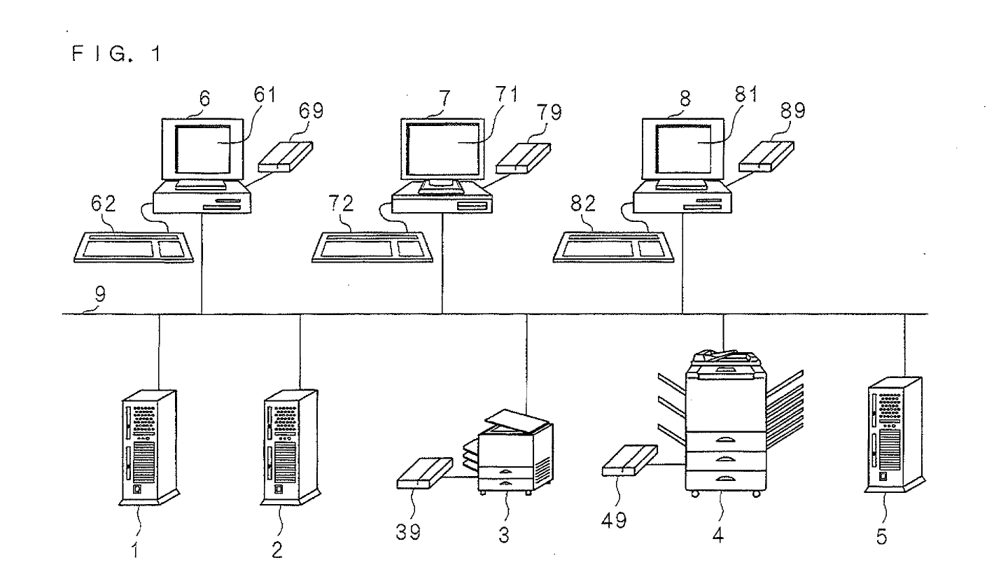

FIG. 1 is a block diagram illustrating an example of a configuration of an authentication print system according to Embodiment 1 of the present invention. In the drawing, a reference numeral 1 denotes a distribution server (information processing apparatus) for generating and distributing setting information and, the distribution server 1 connects via a LAN 9 to an authentication server (authentication apparatus) 2 for authenticating authentication information, and to client PCs (second information processing apparatus) 6, 7, and 8. The client PCs 6, 7, and 8 have display sections 61, 71, and 81 composed of LCD and keyboards 62, 72, and 82 respectively. The LAN 9 also connects to a print server 5 for temporarily storing print data (image data) from the client PCs 6, 7, and 8, and to MFPs (Multi Function Peripheral; image processing apparatus) 3 and 4 for performing printing on the basis of the print data from the print server 5. The client PCs 6, 7, and 8 have IC card readers (acquisition apparatus) 69, 79, and 89 for acquiring the authentication information from an IC card of a user to which the setting information is to be distributed, respectively. The MFPs 3 and 4 have respectively IC card readers 39 and 49 for acquiring the authentication information from the IC card of a user who is to be permitted to use the MFP 3 or 4.

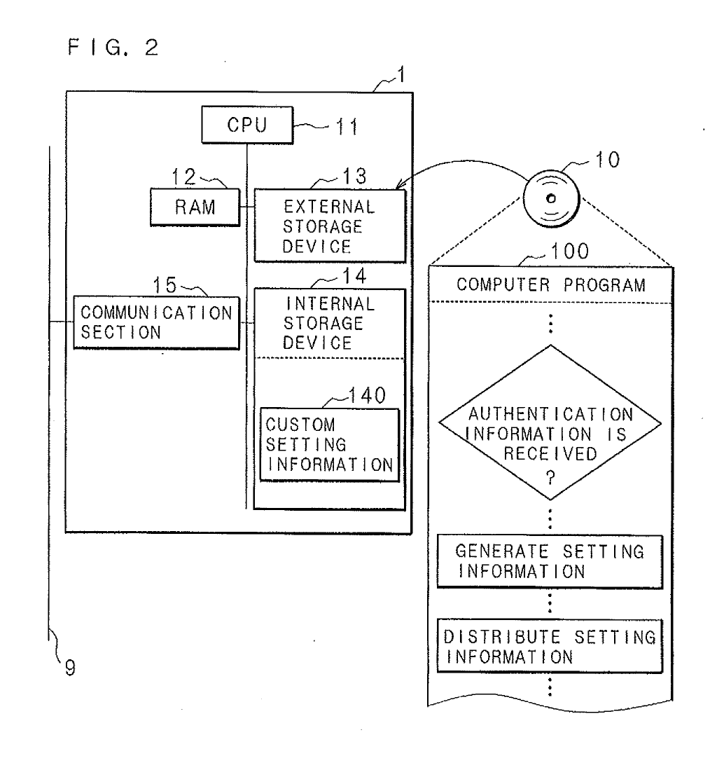

FIG. 2 is a block diagram illustrating a configuration of the principal part of the distribution server 1. The distribution server 1 includes a CPU 11 for performing processing such as an arithmetic operation or the like. The CPU 11 connects via a bus to a RAM 12 for storing temporary information resulting from the processing, an external storage device 13 such as a CD-ROM drive or the like, an internal storage device 14 such as a hard disk or the like, and a communication section 15 for communicating with an external device via the LAN 9. The CPU 11 reads a computer program 100 from a recording medium 10 such as a CD-ROM or the like by using the external storage device 13, and causes the internal storage device 14 to store the read computer program 100. The computer program 100 may be permanently stored in the internal storage device 14. The computer program 100 is loaded from the internal storage device 14 into the RAM 12 on an as needed basis, and the CPU 11 executes processing required by the distribution server 1 on the basis of the loaded computer program 100. The distribution server 1 temporarily stores the generated setting information in the internal storage device 14 as custom setting information 140, but the distribution server 1 may also store the generated setting information in the RAM 12.

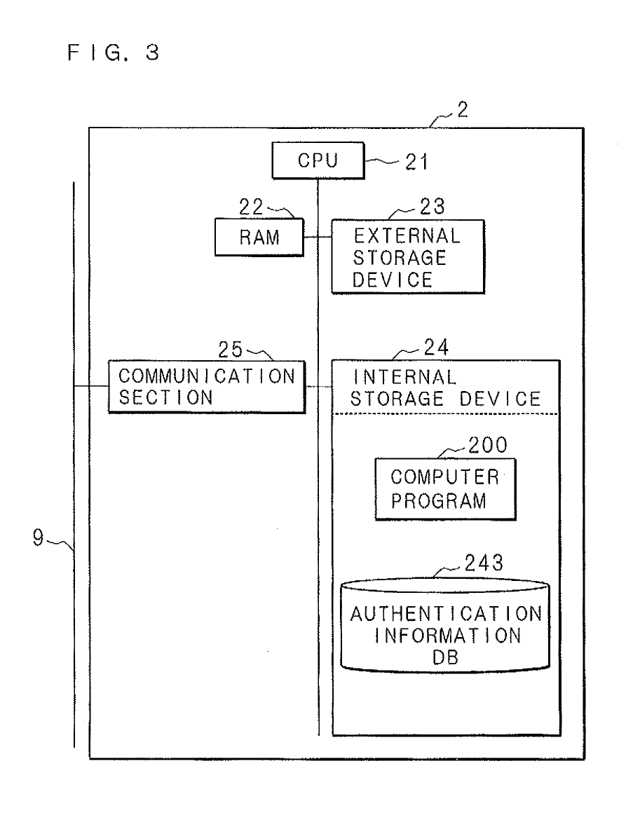

FIG. 3 is a block diagram illustrating a configuration of the principal part of the authentication server 2. The authentication server 2 includes a CPU 21 for performing processing such as the arithmetic operation or the like. The CPU 21 connects via a bus to a RAM 22 for storing temporary information resulting from the processing, an external storage device 23 such as the CD-ROM drive or the like, an internal storage device 24 such as the hard disk or the like, and a communication section 25 for communicating with an external device via the LAN 9. The internal storage device 24 stores a computer program 200 to be executed by the CPU 21. The computer program 200 is loaded from the internal storage device 24 into the RAM 22 on an as needed basis, and the CPU 21 executes processing required by the authentication server 2 on the basis of the loaded computer program 200. In addition, the internal storage device 24 stores an authentication information DB 243 for recording authentication information such as an ID and/or a password required to authenticate users of the client PCs 6, 7, and 8. In Embodiment 1, an e-mail address of the user is included in the authentication information, and the authentication information including the e-mail address is stored. Furthermore, an attribute of the user (e.g., his or her department) to be authenticated based on the authentication information may also be stored in the authentication information DB 243.

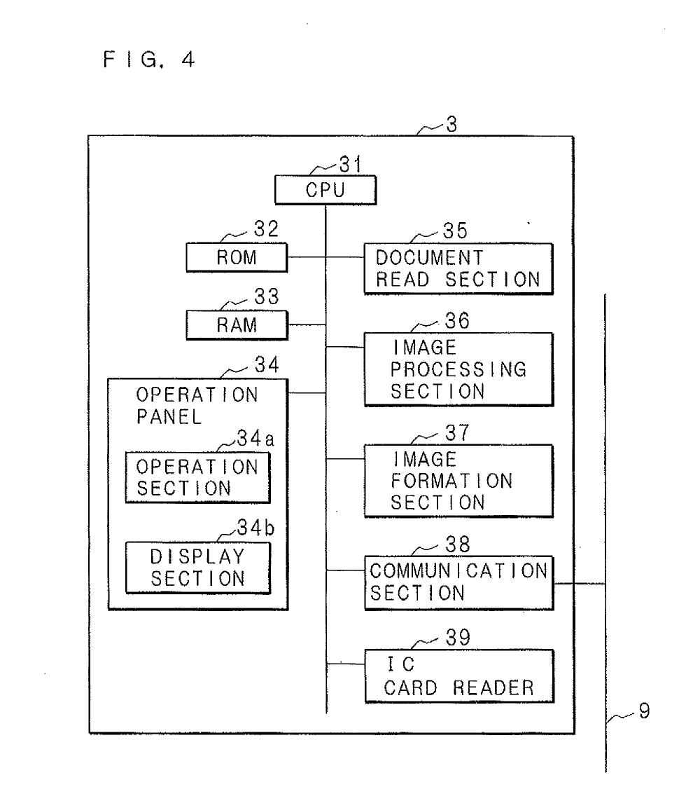

FIG. 4 is a block diagram illustrating a configuration of the principal part of the MFP 3. The configuration of the principal part of the MFP 4 is the same as that of the MFP 3. The MFP 3 includes a CPU 31. The CPU 31 connects via a bus to a ROM 32 for storing information such as a program or the like, and a RAM 33 for storing temporarily generated information. The CPU 31 executes processing such as input and output processing and/or an arithmetic operation, and the like in accordance with a control program pre-stored in the ROM 32. In addition, the CPU 31 also connects via a bus to an operation panel 34, a document read section 35, an image processing section 36, an image formation section 37, and a communication section 38. The operation panel 34 has an operation section 34a for accepting a user operation, and a display section 34b composed of an LCD. The document read section 35 reads a document to acquire image data. The image processing section 36 converts the image data acquired by the document read section 35 into data suitable for print processing. The image formation section 37 forms an image on the basis of the image data. The communication section 38 communicates with an external device via the LAN 9. The communication section 38 has a modem (not illustrated) for performing facsimile communication with other facsimiles including the MFP 4.

In the configuration described above, when print data to be printed by the MFP 3 or 4 is generated by the client PCs 6, 7, or 8 in which a device driver for the image formation section 37 of the MFP 3 or 4 is installed, the authentication server 2 authenticates authentication information newly acquired from each of the IC card readers 39 and 49. When the authentication server 2 affirmatively authenticates the authentication information, the MFP 3 or 4 performs printing on a paper medium on the basis of the print data to which the same authentication information as the authenticated authentication information is added.

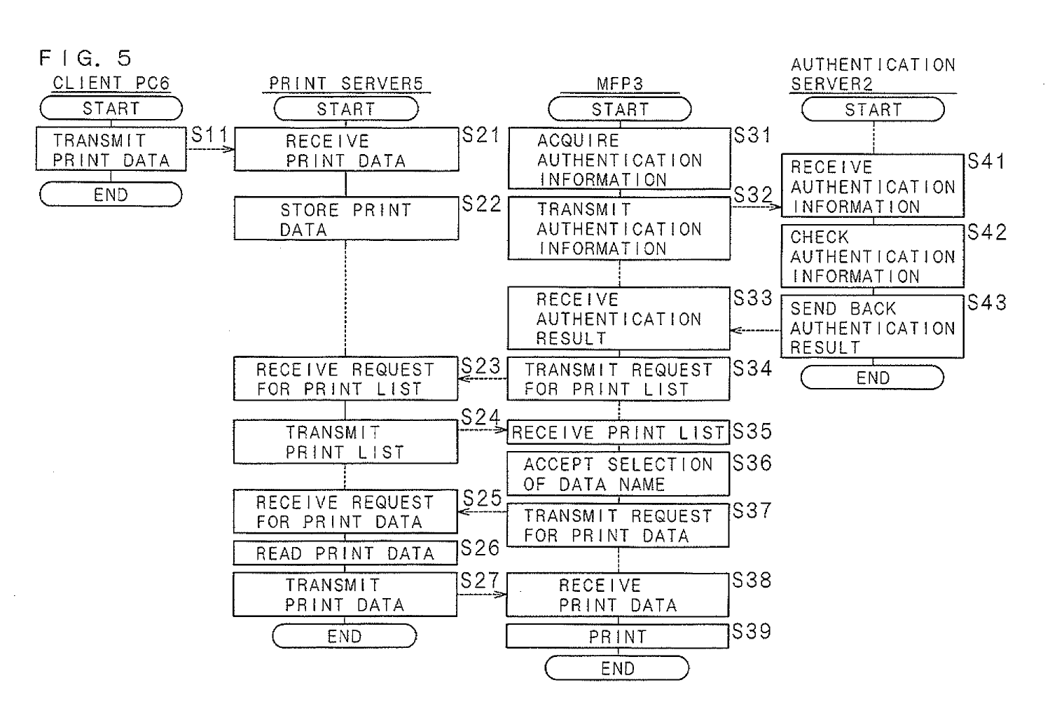

Next, an outline of the standard authentication print system will be described. FIG. 5 is a flowchart illustrating an outline of a routine of each CPU in the authentication print system. In FIG. 5, a description will be given of a case where the MFP 3 normally performs printing on the basis of the print data generated by the client PC 6.

When the print data is generated in the client PC 6, a CPU of the client PC 6 (hereinafter referred to as a CPU-A), which is not illustrated, transmits the print data to which the authentication information of the user using the client PC 6 is added to the print server 5 (S11), and terminates the processing. Thereafter, when a CPU of the print server 5 (hereinafter referred to as a CPU-B), which is not illustrated, receives the print data (S21), the CPU-B temporarily stores the received print data in a storage section, which is not illustrated (S22).

On the other hand, when the user using the client PC 6 inserts an IC card recording the authentication information of the user into the IC card reader 39 of the MFP 3 to authenticate the authentication information, the CPU 31 of the MFP 3 acquires the authentication information from the IC card reader 39 (S31), and transmits the acquired authentication information to the authentication server 2 through the communication section 38 (S32). Herein, although the authentication of the authentication information is carried out by the insertion into the IC card reader 39 by the user, the authentication of the authentication information may also be carried out by the inputting of the authentication information from the operation section 34a by the user.

Next, when the CPU 21 of the authentication server 2 receives the authentication information through the communication section 25 (S41), the CPU 21 checks the received authentication information against authentication information stored in the authentication information DB 243 (S42), and thereby authenticates the received authentication information. It is assumed herein that the received authentication information is authentication information of a regular user, and matches with one of the authentication information items stored in the authentication information DB 243. Thereafter, the CPU 21 sends back an authentication result indicating that the received authentication information matches with one of the authentication information items stored in the authentication information DB 243 and is affirmatively authenticated to the MFP 3 through the communication section 25 (S43), and terminates the processing.

Subsequently, when the CPU 31 of the MFP 3 receives the authentication result sent back from the authentication server 2 through the communication section 38 (S33), and evaluates that the authentication information is affirmatively authenticated, the CPU 31 transmits a request for a print list in which a data name of the print data including the authentication information is described to the print server 5 through the communication section 38 (S34). Thereafter, when the CPU-B of the print server 5 receives the request for the print list transmitted from the MFP 3 (S23), the CPU-B generates the requested print list, and transmits the generated print list to the MFP 3 (S24).

Then, when the CPU 31 of the MFP 3 receives the print list transmitted from the authentication server 2 through the communication section 38 (S35), the CPU 31 displays the received print list on the display section 34b, and accepts the selection of the data name of the print data from the user (S36). Thereafter, when the user selects the data name, the CPU 31 transmits a request for the print data of the selected data name to the print server 5 through the communication section 38 (S37).

Next, when the CPU-B of the print server 5 receives the request for the print data transmitted from the MFP 3 (S25), the CPU-B reads the requested print data from the storage section (S26), transmits the read print data toward the MFP 3 (S27), and terminates the processing. Thereafter, when the CPU 31 of the MFP 3 receives the print data transmitted from the print server 5 through the communication section 38 (S38), the CPU 31 causes the image formation section 37 to print (form) an image on the basis of the received print data (S39). Then, the CPU 31 terminates the processing.

While one example of the authentication print system is illustrated in FIG. 5, there is another example. In another example, the MFP 3 stores the print data transmitted from the client PC 6 and, when the user inserts the IC card into the IC card reader 39, the MFP 3 checks the authentication information acquired from the IC card against the authentication information included in the stored print data. Subsequently, when the authentication information items match with each other, the MFP 3 prints the image on the basis of the print data to which the authentication information is added. In another example of the authentication print system, the print server 5 and the authentication server 2 are not used, and the so-called a hold print (confidential print) is performed.

Hereinbelow, a description will be given of processing in which the distribution server 1 generates the custom setting information 140 for setting parameters in correspondence to a user of the client PC 6 in the device driver (printer driver) for the image formation section (printer section) 37 of the MFP 3 or 4, and distributes the generated setting information 140 to an address of the user. The description of the generation and the distribution of the custom setting information 140 for users of the client PCs 7 and 8 is the same as the description of the generation and the distribution of the custom setting information 140 for the user of the client PC 6.

The distribution server 1 generates the custom setting information 140 on the basis of the authentication information acquired by the IC card reader 69 and authenticated by the authentication server 2, and distributes the generated custom setting information 140 to the address of the user to be authenticated based on the authentication information.

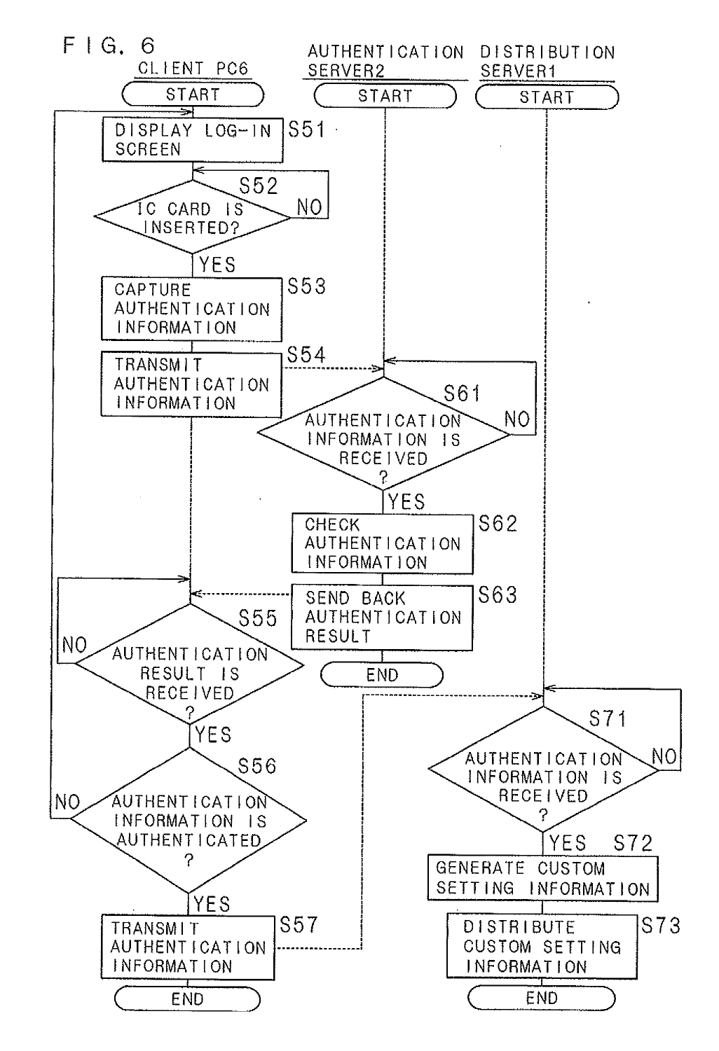

FIG. 6 is a flowchart illustrating a routine of each CPU in the client PC 6, the authentication server 2, and the distribution server 1, which are involved in the generation and the distribution of the custom setting information 140. FIG. 6 illustrates the routine in a case where the user scheduled to use the client PC 6 causes the client PC 6 to acquire the authentication information by using the IC card reader 69. In the client PC 6, the user enables “user authentication function” by using the display section 61 and the keyboard 62, and the CPU-A thereby starts the processing of FIG. 6. In the authentication server 2, every time the authentication of one authentication information is completed, the CPU 21 starts the processing of FIG. 6. In the distribution server 1, every time one custom setting information 140 is generated and distributed, the CPU 11 starts the processing of FIG. 6. Furthermore, the authentication information of the user is pre-stored in the authentication information DB 243 in Embodiment 1.

In the client PC 6, the CPU-A displays a log-in screen on the display section 61 (S51), and evaluates whether or not the IC card is inserted into the IC card reader 69 (S52). When the CPU-A evaluates that the IC card is not inserted (S52: NO), the CPU-A repeats the evaluation of whether or not the IC card is inserted. When the CPU-A evaluates that the IC card is inserted by the user (S52: YES), the CPU-A captures the authentication information recorded in the IC card from the IC card reader 69 (S53), and transmits the captured authentication information toward the authentication server 2 (S54).

In the authentication server 2, the CPU 21 evaluates whether or not the authentication information is received through the communication section 25 (S61). When the CPU 21 evaluates that the authentication information is not received (S61: NO), the CPU 21 repeats the evaluation of whether or not the authentication information is received. When the CPU 21 evaluates that the authentication information is received (S61: YES), the CPU 21 checks the received authentication information against the authentication information stored in the authentication information DB 243 (S62) to authenticate the received authentication information. The CPU 21 sends back the authentication result to the client PC 6 through the communication section 25 (S63), and terminates the processing. Furthermore, in Embodiment 1, when the authentication information is affirmatively authenticated in the step S62, the CPU 21 extracts the e-mail address of the authenticated user from the authentication information DB 243, adds the extracted e-mail address in the authentication result, and sends back the authentication result to the client PC 6 in the step S63. Herein, the CPU 21 may further extract an attribute of the authenticated user from the authentication information DB 243, adds the extracted attribute in the authentication result, and send back the authentication result to the client PC 6.

Next, the CPU-A of the client PC 6 evaluates whether or not the authentication result is received from the authentication server 2 (S55). When the CPU-A evaluates that the authentication result is not received (S55: NO), the CPU-A repeats the evaluation of whether or not the authentication result is received. When the CPU-A evaluates that the authentication result is received (S55: YES), the CPU-A evaluates whether or not the authentication information is affirmatively authenticated (S56). When the CPU-A evaluates that the authentication information is not authenticated (S56: NO), the CPU-A returns the processing to the step S51. When the CPU-A evaluates that the authentication information is authenticated (S56: YES), the CPU-A transmits the authentication information including the e-mail address of the authenticated user to the distribution server 1 (S57), and terminates the processing. Furthermore, when the CPU-A receives the attribute of the user included in the authentication result in the step S55, the CPU-A may transmit the received attribute together with the authentication information in the step S57.

In the distribution server 1, the CPU 11 evaluates whether or not the authentication information is received (S71). When the CPU 11 evaluates that the authentication information is not received (S71: NO), the CPU-11 repeats the evaluation of whether or not the authentication information is received. When the CPU 11 evaluates that the authentication information is received (S71: YES), the CPU 11 generates the custom setting information 140 on the basis of the received authentication information (S72). Furthermore, when the CPU 11 receives the attribute of the user together with the authentication information in the step S71, the CPU 11 may generate the custom setting information 140 further including a parameter in correspondence to the received attribute of the user in the step S72. Thereafter, the CPU 11 distributes the generated custom setting information 140 to the address of the user to be authenticated based on the authentication information (S73), and terminates the processing. Specifically, the CPU 11 transmits an e-mail to which the custom setting information 140 is attached to a mail server, which is not illustrated, by using the e-mail address of the user included in the authentication information as a recipient address.

Next, a description will be given of an example of a method for setting the custom setting information 140 distributed to the user in the device driver.

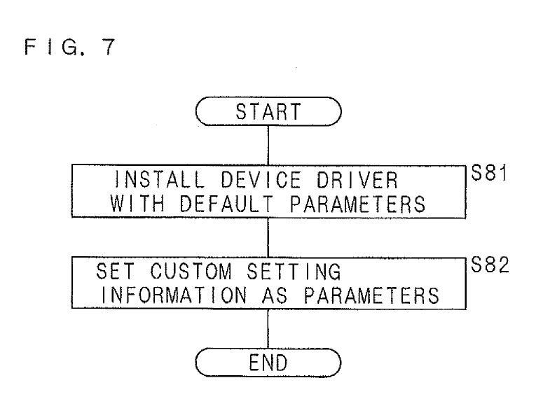

FIG. 7 is a flowchart illustrating a routine of the CPU (CPU-A) of the client PC 6 involved in the execution of all installer of the device driver. When the separately prepared installer of the device driver is executed in the client PC 6, the CPU-A installs the device driver with default parameters (S81). Specifically, the CPU-A installs the device driver for the image formation section 37 of the MFP 3 or 4 in the client PC 6. Thereafter, the CPU-A sets the custom setting information 140 distributed from the distribution server 1 as the parameters of the device driver (S82), and terminates the processing. When the parameter in correspondence to the attribute of the user is included in the custom setting information 140, the CPU-A may further set the parameter in correspondence to the attribute appropriately in the step S82.

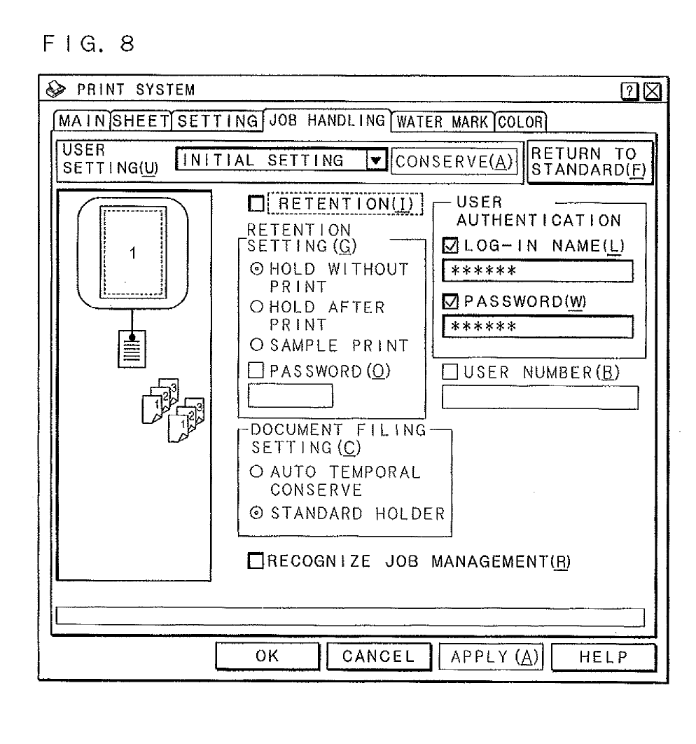

FIG. 8 is an explanatory view illustrating an example of a setting screen of the device driver installed in the client PC 6. The above-mentioned setting screen includes six screens to be selected by using tabs. Among them, when a “job handling” tab is selected, there is displayed a screen for setting whether or not “user authentication” is performed, and for inputting “log-in name” and “password” when the authentication is performed. When a printer setting screen for the MFP 3 or 4 is opened after the installer of the device driver is executed in the client PC 6, for example, the printer setting screen is displayed in a state where the authentication information (log-in name and password) is set, as illustrated in FIG. 8. Furthermore, when the installer of the device driver is executed and the parameter in correspondence to the attribute of the user is set, e.g., when a parameter which prohibits other employees other than a specific employee from performing color printing is set, in the printer setting screen set by using the setting information in correspondence to the authentication information of other employees other than the specific employee, the color printing cannot be selected in the display screen even if a “color” tab in FIG. 8 is selected.

As described above, according to Embodiment 1, the distribution server receives the authenticated authentication information of the user to which the custom setting information is to be distributed, and distributes the custom setting information generated on the basis of the received authentication information to the address of the authenticated user. In addition, the distributed custom setting information is applied at the time of installation of the printer driver in the client PC, whereby the setting of the parameters in correspondence to the user is performed.

Consequently, it becomes possible for the distribution server to generate the setting information for performing the setting of the parameters required for executing predetermined software in correspondence to the user on the basis of the authentication information of the user, and distribute the generated setting information to the address of the user.

In addition, the client PC causes the authentication apparatus to authenticate the authentication information acquired via the card reader, the client PC having the card reader transmits the authenticated authentication information to the distribution server, and the distribution server distributes the custom setting information generated on the basis of the received authentication information to the address of the authenticated user.

Consequently, it becomes possible to distribute the setting information generated on the basis of the authentication information acquired from the card reader of the client PC to the address of the user who has caused the card reader to read the card.

Further, since the client PC, which the user to which the custom setting information is to be distributed is scheduled to use, has the card reader in order to function also as the acquisition apparatus, it becomes possible to save the user from moving to the place where another acquisition apparatus is installed for the authentication.

Furthermore, the authentication server extracts the attribute of the authenticated user from the attributes pre-stored in the authentication information DB, and adds the extracted attribute in the authentication result. The client PC having the card reader receives the authentication result including the attribute of the user from the authentication server, and transmits the received authentication result including the attribute of the user to the distribution server. Subsequently, the distribution server adds the information in correspondence to the attribute of the user that is received from the client PC in the custom setting information. Further, the distributed custom setting information is applied at the time of installation of the printer driver in the client PC, and the setting of the parameter in correspondence to the attribute of the user is thereby performed in addition to the setting of the parameters in correspondence to the user.

Consequently, it becomes possible to distribute the setting information including the information in correspondence to the attribute of the authenticated user to the address of the authenticated user.

Moreover, the distribution server distributes the custom setting information for setting the parameters in the device driver (printer driver) for the image formation section of the MFP for printing (forming) the image on the basis of the print data from the client PC.

Consequently, it is possible to distribute the setting information allowing errorless setting of the parameters in correspondence to the user in the printer driver, which is considered to cause troubles easily at the time of software installation.

Furthermore, the distribution sever 1 transmits the e-mail having the generated custom setting information 140 attached thereto to the address of the user in Embodiment 1. However, the distribution server 1 may write an URL at which the custom setting information 140 to be distributed is uploaded in the body of the e-mail to be transmitted to the address of the user and transmit the e-mail, and the client PC 6 (or 7 or 8) may download the custom setting information 140 by using a Web browser. Further, the distribution server 1 may write the content of the custom setting information 140 in a portable recording medium, and the user may manually distribute the recording medium having the content of the custom setting information 140 written therein to the client PC 6 (or 7 or 8).

Furthermore, the distribution server 1 may transmit the custom setting information 140 to the client PC 6, 7, or 8 associated with each user, and the client PC 6, 7, or 8 may receive the custom setting information 140 by using application software.

### Embodiment 2

In Embodiment 1, the distribution server 1 generates the custom setting information 140 of the printer driver, while in Embodiment 2, a distribution server 1a adds the setting information in an original installer 141 of the printer driver to thereby generate a custom installer 142.

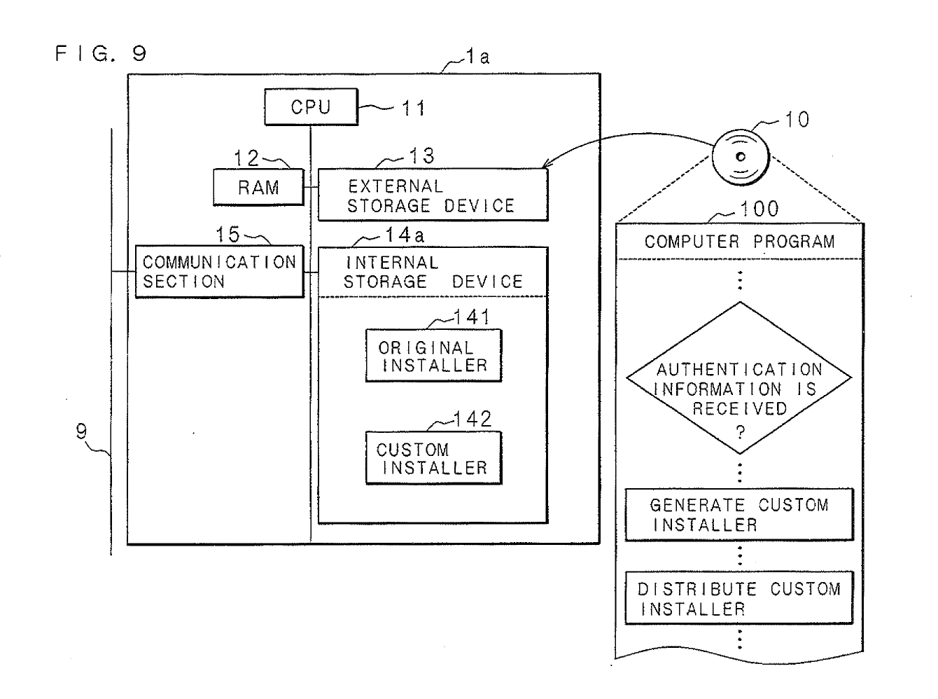

FIG. 9 is a block diagram illustrating a configuration of the principal part of the distribution server 1a according to Embodiment 2 of the present invention. The distribution server 1a includes the CPU 11 for performing processing such as the arithmetic operation or the like. The CPU 11 connects via a bus to the RAM 12 for storing temporary information resulting from the processing, the external storage device 13 such as the CD-ROM drive or the like, an internal storage device 14a such as the hard disk or the like, and the communication section 15 for communicating with an external device via the LAN 9. The internal storage device 14a stores, as the original installer 141, the installer of the device driver (printer driver) for the image formation section (printer section) 37 of the MFP 3 or 4, which serves as a base when the distribution server 1a generates an installer (installation software). Although the distribution server 1a temporarily stores the generated installer in the internal storage device 14a as the custom installer 142, the distribution server 1a may also store the generated installer in the RAM 12.

Hereinbelow, a description will be given of processing in which the distribution server 1a generates the custom installer 142 including setting information for setting parameters in correspondence to a user using the client PC 6 in the original installer 141 of the device driver for the image formation section 37 of the MFP 3 or 4, and distributes the generated custom installer 142 to the address of the user. The description of the generation and the distribution of the custom installer 142 for users of the client PCs 7 and 8 is the same as the description of the generation and the distribution of the custom installer 142 for the user of the client PC 6.

The distribution server 1a generates the custom installer 142 on the basis of the authentication information acquired by the IC card reader 69 and authenticated by the authentication server 2 and the original installer 141, and distributes the generated custom installer 142 to the address of the user to be authenticated based on the authentication information.

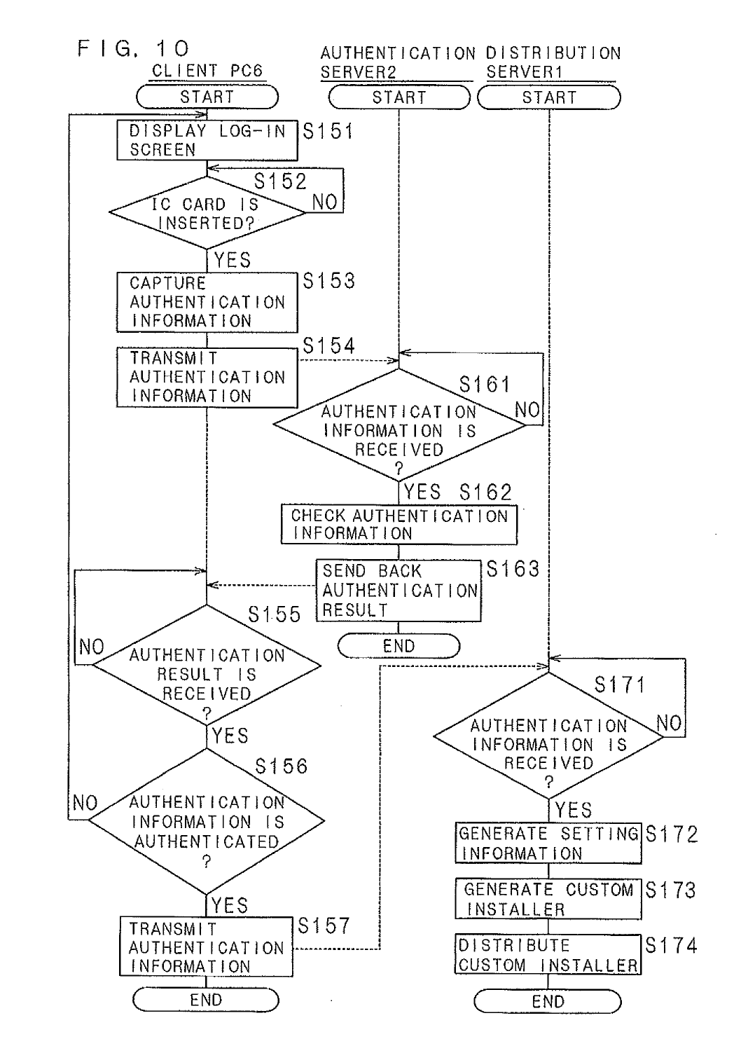

FIG. 10 is a flowchart illustrating a routine of each CPU in the client PC 6, the authentication server 2, and the distribution server 1a, which are involved in the generation and the distribution of the custom installer 142. FIG. 10 illustrates the routine in a case where the user scheduled to use the client PC 6 causes the client PC 6 to acquire the authentication information by using the IC card reader 69. Conditions under which each CPU in the client PC 6, the authentication server 2, and the distribution server 1a starts the processing illustrated in FIG. 10 are the same as the conditions under which each CPU starts the processing illustrated in FIG. 6, which has been described in Embodiment 1.

The processing in steps S151 to S157 in the client PC 6 is the same as the processing in the steps S51 to S57 illustrated in FIG. 6, which has been described in Embodiment 1. Accordingly, the description of the processing in the steps S151 to S157 will be omitted. In addition, the processing in steps S161 to S163 executed by the CPU 21 of the authentication server 2 is the same as the processing in the steps S61 to S63 illustrated in FIG. 6 and executed by the CPU 21 of the authentication server 2, which has been described in Embodiment 1. Accordingly, the description of the processing in the steps S161 to S163 will be omitted.

In the distribution server 1a, the CPU 11 evaluates whether or not the authentication information is received from the client PC 6 (S171). When the CPU 11 evaluates that the authentication information is not received (S171: NO), the CPU 11 repeats the evaluation of whether or not the authentication information is received. When the CPU 11 evaluates that the authentication information is received (S171: YES), the CPU 11 generates the setting information on the basis of the received authentication information (S172). Herein, in the same manner as in the step S72 of FIG. 6 in Embodiment 1, the CPU 11 may further add the parameter in correspondence to the attribute of the user in the setting information. Thereafter, the CPU 11 adds the generated setting information in the original installer 141 stored in the internal storage device 14a to thereby generate the custom installer 142 (S173). Subsequently, the CPU 11 distributes the custom installer 142 generated in the step S173 to the address of the user to be authenticated based on the authentication information (S174), and terminates the processing.

Next, the generated custom installer 142 will be described.

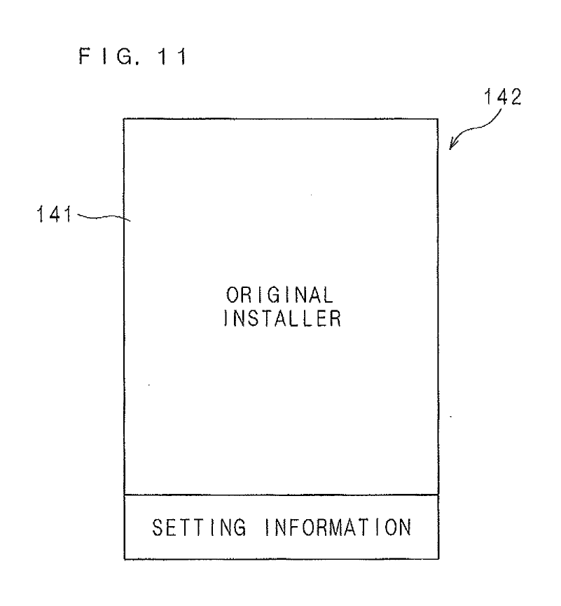

FIG. 11 is an explanatory view illustrating a configuration of the custom installer 142. The custom installer 142 is constituted as a program module including the original installer 141 and the setting information on the basis of the authentication information of the user of the client PC 6, 7, or 8 in which the custom installer 142 is to be executed. When the custom installer 142 constituted as illustrated in FIG. 11 is executed in the client PC 6, 7, or 8, the setting information is applied to the device driver installed by the original installer 141, and the setting of the parameters in correspondence to the user is performed.

As for other parts corresponding to those in Embodiment 1, the detailed description thereof will be omitted by retaining the same reference numerals.

As described above, according to Embodiment 2, since the setting information and the installer of the device driver are included in the custom installer to be distributed, it becomes possible to distribute the necessary setting information to the user at the time of installation of predetermined software at a time.

In addition, an installation package of the device driver is distributed as the custom installer, which is customized on a per user basis.

Consequently, it becomes possible to perform the installation of the predetermined software and the setting of the parameters in correspondence to the user in the installed software at a time when the distributed installation package is acquired and executed by the client PC at a time.

In Embodiment 2, although the distribution server 1a has added the setting information in the original installer 141 to thereby generate the custom installer 142, the generation thereof is not limited thereto. The distribution sever 1a may newly generate the custom installer 142 including the setting information on a per authenticated user basis.

In addition, the distribution server 1a may distribute a custom package generated by adding the setting information in software, which does not function as the installer. With this operation, it becomes possible for the distribution server 1a to distribute the necessary setting information at the time of installation of the software described above at a time.

Further, although the MFPs 3 and 4 have been used as the image processing apparatus in Embodiments 1 and 2, the image processing apparatus is not limited thereto. An apparatus for performing image analysis or image measurement may be used, or an image formation apparatus dedicated to image formation (printer) may also be used.

Furthermore, although the authentication information of the user has been acquired by using the IC card reader 69 of the client PC 6 in Embodiments 1 and 2, the authentication information of the user may be acquired by, e.g., reading a finger vein pattern using an infrared scanner, or the authentication information stored in the IC card of the user may be acquired by using the IC card reader 39 or 49 of the MFP 3 or 4.

Moreover, in Embodiments 1 and 2, it is possible to record the above-described method for generating and distributing the setting information in another computer-readable recording medium in which a program code (executable program, intermediate code program, or source program) of the computer program 100 is recorded. In this manner, the recording medium recording the program for performing the above-described method can be portably provided.

As the recording medium, a memory for executing process in a microcomputer (not illustrated), e.g., a program medium such as a ROM may be used, or a program medium which becomes readable by inserting a recording medium into a program reading device (not illustrated) provided as an external storage device may also be used. No matter which program medium is used as the recording medium, the program code stored in the recording medium may be accessed and executed by the CPU 11, or the program code may be read from the recording medium, downloaded into, e.g., a program storage area of the RAM 12, and executed. A program for downloading the program code is assumed to be pre-stored in the main unit of the distribution server 1 or 1a.

The program medium is a recording medium constituted so as to be detachable from the main unit, and may also be the one, which fixedly holds the program code in a tape medium, a disk medium, a card medium, or a semiconductor memory medium. Herein, the tape medium includes a magnetic tape or a cassette tape. The disk medium includes a magnetic disk represented by a flexible disk or a hard disk, or an optical disk represented by a CD-ROM, an MO, an MD, or a DVD. The card medium includes an IC card (inclusive of a memory card) or an optical card. The semiconductor memory medium includes a mask ROM, an EPROM (Erasable Programmable Read Only Memory), an EEPROM (Electrically Erasable Programmable Read Only Memory), or a flash ROM.

The program medium may also be a medium in which the program code is held in a flowing manner such that the program code can be downloaded from a communication network including the Internet. In a case where the program code is downloaded from the communication network in this manner, a program for downloading the program code may be a program pre-stored in the main unit of the distribution server 1 or 1a, or may also be a program installed from other recording media. Furthermore, the communication network is not particularly limited. As the communication network, it is possible to use the Internet, an intranet, an extranet, a LAN, an ISDN, a VAN, a CATV communication network, a virtual private network, a telephone network, a mobile communication network, or a satellite communication network.

In addition, a transmission medium constituting the communication network is not particularly limited. As the transmission medium, it is possible to use a wired type or a wireless type. The wired type includes an IEEE 1394, a USB, a power-line carrier, a cable TV line, a telephone line, or an ADSL line. The wireless type includes an infrared ray of IrDA or a remote controller, Bluetooth (registered trademark), an 802.11 radio, an HDR, a mobile phone network, a satellite line, or a terrestrial digital network. Furthermore, the present invention may be realized in the form of a computer data signal, which is realized by electronic transmission of the program code embedded in a carrier wave.

As this description may be embodied in several forms without departing from the spirit of essential characteristics thereof, the present embodiment is therefore illustrative and not restrictive, since the scope is defined by the appended claims rather than by the description preceding them, and all changes that fall within metes and bounds of the claims, or equivalence of such metes and bounds thereof are therefore intended to be embraced by the claims.

What is claimed is:

1. A software distribution method for generating and distributing, by using an information processing apparatus, setting information for setting a parameter required for executing predetermined software by a second information processing apparatus,
wherein the information processing apparatus performs steps of:
receiving authentication information;
generating the setting information on the basis of the received authentication information; and
distributing the generated setting information to an address of a user to be authenticated based on the authentication information.

2. The software distribution method according to claim 1,
wherein the predetermined software and the setting information are distributed in the step of distributing the generated setting information to the address of the user.

3. The software distribution method according to claim 2,
wherein the information processing apparatus performs steps of:
adding the setting information in the predetermined software; and
generating installation software for installing the predetermined software in the second information processing apparatus,
wherein the installation software is distributed in the step of distributing the generated setting information to the address of the user.

4. The software distribution method according to claim 1,
wherein the predetermined software is a device driver for an image formation apparatus for forming an image on the basis of image data transmitted by the second information processing apparatus.

5. A software distribution method for generating and distributing setting information for setting a parameter required for executing predetermined software by a second information processing apparatus by using a system including an information processing apparatus, an acquisition apparatus communicably connected to the information processing apparatus and acquiring authentication information, and an authentication apparatus communicably connected to the acquisition apparatus and receiving and authenticating the authentication information and transmitting an authentication result to a transmission source of the authentication information,
wherein the acquisition apparatus performs steps of:
transmitting the acquired authentication information to the authentication apparatus;
receiving the authentication result; and
transmitting the authenticated authentication information to the information processing apparatus,
wherein the information processing apparatus performs steps of:
receiving the authentication information;
generating the setting information on the basis of the received authentication information; and
distributing the generated setting information to an address of a user to be authenticated based on the authentication information.

6. The software distribution method according to claim 5,
wherein the second information processing apparatus also functions as the acquisition apparatus.

7. The software distribution method according to claim 5,
wherein the authentication apparatus performs steps of:
pre-storing an attribute of the user to be authenticated based on the authentication information;
extracting the attribute of the authenticated user from the stored attribute; and
adding the extracted attribute of the user in the authentication result,
wherein the acquisition apparatus performs a step of:
transmitting the attribute of the user included in the received authentication result to the information processing apparatus,
wherein the information processing apparatus performs steps of:
receiving the attribute of the user; and
adding information in correspondence to the received attribute of the user in the setting information.

8. The software distribution method according to claim 5,
wherein the predetermined software and the setting information are distributed in the step of distributing the generated setting information to the address of the user.

9. The software distribution method according to claim 8,
wherein the information processing apparatus performs steps of:
adding the setting information in the predetermined software; and
generating installation software for installing the predetermined software in the second information processing apparatus,
wherein the installation software is distributed in the step of distributing the generated setting information to the address of the user.

10. The software distribution method according to claim 5,
wherein the predetermined software is a device driver for an image formation apparatus for forming an image on the basis of image data transmitted by the second information processing apparatus.

11. An information processing apparatus, comprising:
a reception section receiving authentication information;
a generation section generating, on the basis of the authentication information received by the reception section, setting information for setting a parameter required for executing predetermined software by a second information processing apparatus; and
a distribution section distributing the setting information generated by the generation section to an address of a user to be authenticated based on the authentication information.

12. The information processing apparatus according to claim 11,
wherein the distribution section distributes the predetermined software and the setting information.

13. The information processing apparatus according to claim 12,
further comprising:
a software generation section adding the setting information in the predetermined software and generating installation software for installing the predetermined software in the second information processing apparatus,
wherein the distribution section distributes the installation software.

14. The information processing apparatus according to claim 11,
wherein the predetermined software is a device driver for an image formation apparatus for forming an image on the basis of image data transmitted by the second information processing apparatus.

15. An information processing system, comprising:
the information processing apparatus according to claim 11;
an acquisition apparatus acquiring authentication information, transmitting the authentication information to an authentication apparatus, receiving an authentication result, and transmitting authenticated authentication information to the information processing apparatus; and
the authentication apparatus receiving and authenticating the authentication information, and transmitting the authentication result to a transmission source of the authentication information.
